(19) United States
(12) Patent Application Publication
(10) Pub. No.: US 2023/0150492 A1
(43) Pub. Date: May 18, 2023

(54) METHOD FOR AUTOMATIC LANE GUIDANCE SYSTEM LANE GUIDANCE SYSTEM FOR AUTOMATIC LANE GUIDANCE OF A VEHICLE

(71) Applicant: KNORR-BREMSE Systeme für Nutzfahrzeuge GmbH, Munich (DE)

(72) Inventors: Simon FLUMM, Wiernsheim (DE); Birgit Schmortte, Stuttgart (DE)

(21) Appl. No.: 17/975,965

(22) Filed: Oct. 28, 2022

(30) Foreign Application Priority Data
Oct. 28, 2021 (DE) DE102021128178.4

(51) Int. Cl. B60W 30/10; B60W 60/00; B60W 10/18; B60W 10/20

(52) U.S. Cl. CPC B60W 30/10; B60W 60/001; B60W 10/18; B60W 10/20; B60W 2555/20; B60W 2710/18; B60W 2710/20; B60W 2420/42

(57) ABSTRACT

A method for automatically guiding a track of a vehicle which includes at least two wheels on each vehicle side and a track guidance system which is able to detect at least one lane groove within a driving lane, the method including influencing a track guidance of the vehicle as a function of a detection of the at least one lane groove, wherein the track guidance system includes a lane groove following mode in which the track guidance of the vehicle is influenced by the track guidance system after the at least one lane groove has been detected so that the vehicle follows the at least one detected lane groove in that at least two wheels at least at one vehicle side are caused to overlap the at least one detected lane groove.

### RELATED APPLICATIONS

This application claims priority from German Patent Application DE 10 2021 128 178.4 filed on Oct. 28, 2021 which is incorporated in its entirety by this reference.

### FIELD OF THE INVENTION

The invention relates to a method for automatic track guidance of a vehicle and a track guidance system for automatic track guidance of a vehicle. The invention furthermore relates to a vehicle.

### BACKGROUND OF THE INVENTION

Lane grooves are road damages configured as lane depressions oriented in a longitudinal direction of a lane. The depressions are created in particular by impressing and compressing asphalt of a lane due to an impact of comparatively large wheel loads of heavy trucks. In order to prevent such road surface wear in the form of grooves DE 10 2017 009 446 A1 proposes a generic method and a generic track guidance system and a highly automated or autonomously driving vehicle with the track guidance system that is intended to achieve an even use of road surfaces, in particular in that the road surfaces are traveled by vehicles with a uniform or individual offset from a road section where a maximum amount of use has occurred in the past.

### BRIEF SUMMARY OF THE INVENTION

It is an object of the invention to provide a method, a track guidance system and a vehicle that helps to improve traffic safety.

The inventors have found that driving through lane grooves with wheels of a vehicle improves driving stability since the wheels of vehicle are guided by the lane grooves in particular when traveling through curves. Due to the improved guidance of the vehicle by the lane grooves a tendency to oversteer or understeer is decreased. Last not least, the lane grooves also mark driving trajectories which the preceding traffic has selected as advantageous or as an optimum ideal line in order to travel through curves swiftly but safely.

Another advantageous embodiment of the invention proposes a method for automatic track guidance of a vehicle which includes at least two wheels on each vehicle side and a track guidance system which is configured to detect at least one lane groove within a driving lane wherein the method influences a track guidance of the vehicle as a function of a detection of at least one lane groove wherein the track guidance system includes at least one lane groove following mode in which the track guidance of the vehicle is influenced by the track guidance system after at least one lane groove has been detected so that the vehicle follows the at least one detected lane groove in that at least two wheels at least at one vehicle side are caused to overlap the at least one detected lane groove.

According to another aspect of the invention a track guidance system configured to automatically guide a track of a vehicle is proposed which includes at least two wheels on each vehicle side, wherein the track guidance system includes a lane groove following mode and

a) a control or regulation device,

b) a sensor device which is configured to detect vehicle environment parameters and which is configured to detect at least one lane groove among the detected vehicle environment parameters within a driving lane and which generates lane groove detection signals when detecting at least one lane groove and feeds the lane groove detection signals into the control or regulation device.

c) at least one actuator controlled or regulated by the control or regulation device as a function of detected vehicle environment parameters wherein the actuator influences the track guidance of the vehicle,

d) wherein the control or regulation device is configured to control or regulate the at least one actuator as a function of the lane groove detection signals, and

e) wherein the track guidance system has a lane groove following mode, and

f) wherein the control or regulation device is configured to control or regulate the at least one actuator in the lane groove following mode when receiving lane groove detection signals so that the vehicle follows the at least one detected lane groove by causing at least two wheels at least at one vehicle side to overlap with the at least one detected lane groove.

Put differently the method according to the invention or the track guidance system according to the invention provides that the vehicle is intentionally guided in a detected or captured lane groove with at least two wheels of different axles which are arranged at an identical vehicle side at least partially autonomously or autonomously.

The actuator is advantageously configured as a steering device of the vehicle. Alternatively, or additionally the actuator can also be a brake device which facilitates brake steering.

Additionally, the lane groove following mode of the track guidance system can be selectable among several modes for track guidance of the vehicle. The selection can thus be performed through a man machine interface by a driver of the vehicle or can be performed automatically, in particular when at least one lane groove is detected on the driving surface.

The features provided in the dependent claims define advantageous embodiments of the invention.

According to an advantageous embodiment, the automatic track guidance of the vehicle is performed by the track guidance system as a function of detected vehicle environment parameters which differ from a detected lane groove when the track guidance system has not detected a lane groove or in a mode of the track guidance system which differs from the lane groove following mode. These vehicle environment parameters can be any parameters which define the environment of the vehicle like e.g. additional static or dynamic obstacles, objects or additional vehicles, a distance, the relative velocity, the relative acceleration with respect to obstacles, objects or other vehicles driving surface markings, lane markings, traffic signs, ambient temperature, relative humidity in an environment of the vehicle, traffic signs, light conditions in the ambient of the vehicle, path of the driving lane and/or the driving surface driven by the (EGO-) vehicle.

According to an advantageous embodiment of the method track guidance of the vehicle is influenced by the track guidance system when the track guidance system has detected two essentially parallel lane grooves within a driving lane, in particular in the lane groove following mode, namely a first lane groove and a second lane groove so that the vehicle follows the two detected lane grooves in that at least two wheels on a first vehicle side are caused to overlap with the first detected lane groove and at least two wheels on a second vehicle side are caused to overlap with the second detected lane grove.

Advantageously this embodiment of the method is only used when a track width of the vehicle corresponds approximately to a track width of the lane grooves. This way the track guidance of the vehicle is further improved because then at least four wheels of the EGO-vehicle are guided by the lane grooves.

The track guidance system can control or regulate the vehicle so that it then follows the at least one detected lane groove when the track guidance system has detected that the at least one lane groove is within a driving lane and the vehicle moves within lane boundaries of the driving lane when following the at least one lane groove. When a path of a driving surface has been altered over time but the previously formed lane grooves are still in existence this prevents that the (EGO-) vehicle exits the driving lane or the driving surface when following the at least one lane groove.

Thus, it can be provided according to the method that the track guidance system detects a wet driving surface of a driving lane and influences the track guidance of the vehicle to follow the at least one detected lane groove only when it does not have detected a wet driving surface or when it has detected a dry driving surface. This avoids negative hydroplaning effects.

According to an advantageous embodiment the track guidance system can be configured that the control device controls the at least one actuator in case the sensor device has not generated any lane groove detection signals or in a mode of the track guidance system that differs from the lane groove following mode so that the automatic track guidance of the vehicle operates on a basis of vehicle environment parameters captured by the sensor device that differ from a detected lane groove.

The track guidance system can also be configured that the control or regulation device controls the at least one actuator so that the vehicle follows the two detected lane grooves by causing at least two wheels on a first vehicle side to overlap with the first detected lane groove and at least two wheels on the second vehicle side are caused to overlap with the second detected lane groove when the sensor device has detected at least two essentially parallel lane grooves within a lane in particular in the lane groove following mode, namely a first lane groove and a second lane groove and has fed corresponding lane groove detection signals to the control and regulation device.

The control and regulation device of the track guidance system can be configured so that it controls or regulates the at least one actuator in particular in the lane groove following mode when receiving lane groove detection signals so that the vehicle follows the at least one detected lane groove only when the sensor device has detected that the at least one lane groove is within a driving lane and the vehicle moves within lane boundaries of the driving lane when following the at least one lane groove.

The sensor device of the track guidance system can be configured so that it can detect a wet driving surface in particular in the lane groove following mode and can feed corresponding wet detection signals to the control or regulation device, wherein the control or regulation device is configured to control or regulate the at least one actuator when simultaneously receiving wet detection signals and lane groove detection signals so that the wheels of the EGO vehicle have an offset from the detected lane grooves.

The actuator of the track guidance system can be e.g. a steering device of the vehicle and the sensor device can be an image capture device including at least one camera. Furthermore, the track guidance system can be configured to perform a partially autonomous track guidance or an autonomous track guidance of the vehicle.

The invention also relates to a vehicle including the track guidance system described supra.

### BRIEF DESCRIPTION OF THE DRAWINGS

An advantageous embodiment of the invention is described with reference to a drawing figure, wherein:

FIG. 1 illustrates a vehicle in an advantageous embodiment of a track guidance system according to the invention;

FIG. 2 illustrates a block diagram of an advantageous embodiment of a method for automatically guiding a track of the vehicle.

### DETAILED DESCRIPTION OF THE INVENTION

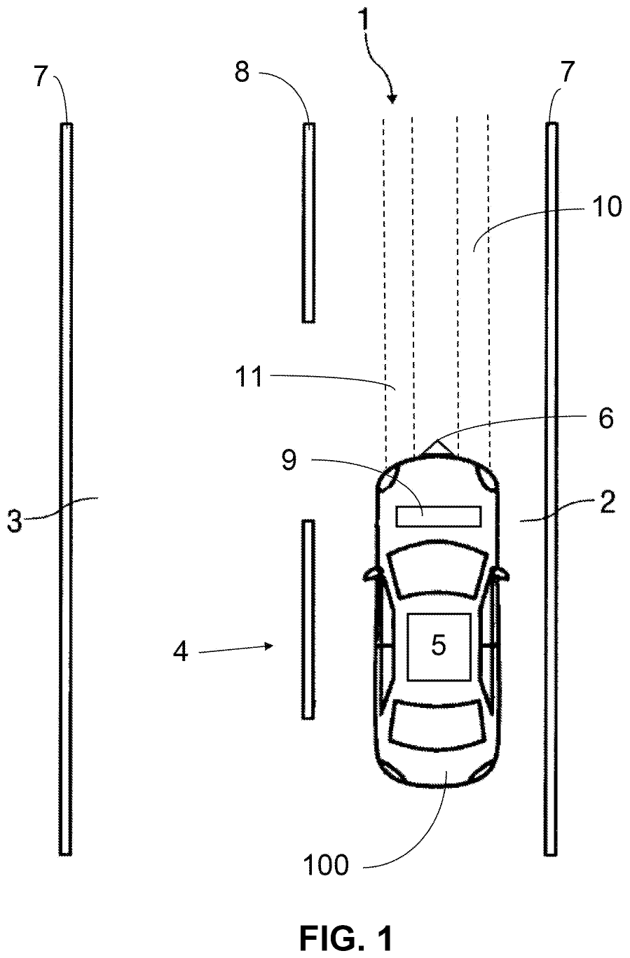

FIG. 1 shows an EGO vehicle 100, configured with an advantageous embodiment of a track guidance system 4 according to the invention wherein the vehicle moves on a two-lane driving surface 1 with two driving lanes, a right driving lane 2 and a left driving lane 3, wherein the vehicle moves on the right driving lane 2, controlled partially autonomously or autonomously controlled e.g. by a control or regulation device 5. The track guidance system 4 is configured e.g. as an on-board system and arranged in its entirety on the EGO vehicle 100 and forms part of the partially autonomous or autonomous control/regulation of the ego vehicle 100. Alternatively, the track guidance system 4 can also be a distributed system wherein parts of the track guidance system 4 can also be arranged in an external unit.

The track guidance system 4 includes an image capture device 6 for a sensor device e.g. configured as a camera, in particular a stereo camera whose detection area is oriented forward from the EGO vehicle 100. The image capture device 8 continuously captures signals that are fed to the control or regulation device 5. Alternatively, or additionally, also one or plural other suitable sensor devices can be used which can detect vehicle environment parameters of the EGO vehicle 100.

The driving surface 1 includes two driving surface boundaries 7 which can also be e.g. a driving lane boundary of the right driving lane and the left driving lane 2,3. Additionally there is a dashed center line 8 arranged between the right and the left driving lane 2, 3 which also form a driving lane boundary of the right and the left driving lane 2, 3. The image capture device 6 can capture and detect the driving surface boundaries 7 and the center line 8 or the driving lane boundaries 7, 8. Furthermore the image capture device 6 is also capable to detect lane grooves 10, 11 on or in the driving surface 1 or on or in the currently driven driving lane 2 wherein the lane grooves are configured e.g. as indentations in the driving surface pavement.

Additionally, the image capture device 6 can detect additional vehicle environment parameters of the EGO vehicle 100 which define an environment of the EGO vehicle 100 like e.g. static or dynamic obstacles, objects or an additional preceding vehicle, distance, relative velocity, relative acceleration with respect to obstacles, objects and/or relative to the additional vehicle, traffic signs and light conditions in the environment of the EGO vehicle 100.

The control or regulation device 5 includes e.g. an auto pilot that is configured to control the EGO vehicle 100 partially autonomously or autonomously. The control or regulation device 5 determines e.g. a nominal drive trajectory for the EGO vehicle 100 along the right driving lane 2 as a function sensor signals put out by the image capture device 6. In particular, the control or regulation device 5 includes lane keeping logic and determines among other things a nominal steering angle configured to guide the EGO vehicle 100 along the nominal drive trajectory, thus within the right driving lane 2. This nominal steering angle is then fed to a steering device 9 of the EGO vehicle 100 so that steerable wheels of a steerable axle of the EGO vehicle 100 are aligned according to the nominal steering angle. The actual steering angle can then be determined e.g. by a steering angle sensor and regulated by the control or regulation device 5 to match the nominal steering angle.

The track guidance system 4 includes in particular a lane groove following mode that is selectable from plural modes wherein the lane groove following mode is selectable or activatable or deactivatable through a man machine interface like an operator console.

The image capture device 6 includes e.g. a processing algorithm which is configured in particular in lane groove following mode to detect a lane groove 10, 11 on or in the driving surface 1 and here in particular in or on the right driving lane 2 based on the sensor signals. When a lane groove 10, 11 is detected on or in the right driving lane 2, the image capture device 6 feeds lane groove detection signals into the control or regulations device 5 which then controls or regulates the steering device 9 in particular in lane groove following mode so that the EGO vehicle 100 follows the detected lane groove 10, 11 by causing two wheels on at least one vehicle side to overlap with the detected lane groove 10, 11.

In the other case when no lane groove 10, 11 is detected by the image capture device 6 in particular in lane groove following mode, the lane groove following mode is exited and the automatic track guidance of the EGO vehicle 100 is then performed e.g. by the track guidance system 4 based on captured vehicle environment parameters which differ from a detected lane groove 10, 11 and which are listed supra.

When two lane grooves, a right lane groove 10 and a left lane groove 11 are captured and detected as shown in FIG. 1 and if the track width of the EGO vehicle 100 essentially corresponds to a track width of the two lane grooves 10, 11 which can be captured and detected by the image capture device 6, the control or regulation device 5 can also control or regulate the steering device 9 so that the EGO vehicle 100 follows the detected lane grooves 10, 11 by causing two wheels on the right vehicle side to overlap with the captured right lane groove 10 and the two wheels on the left vehicle side are caused to overlap with the captured left lane groove 11. Track keeping logic of the track guidance system 4 guides the EGO vehicle 100 in view of its width and track width so that the EGO vehicle 100 is entirely kept in the right driving lane 2. If the lane groove 10 or 11 or the lane grooves lead towards an outside of the driving lane 2 which can occur when a path of the driving surface has been reconfigured or old lane grooves 10, 11 are still present in the driving lane a departure of the lane grooves 10, 11 from the driving surface is captured and detected by the image capturing device 6 and further following of the lane grooves 10, 11 by the control or regulation device of the EGO vehicle is prevented in that the lane groove following mode is automatically exited.

The advantageous track guidance system 4 includes an image capture device 6 capable of detecting a wet driving surface 1 and feeding corresponding wet detection signals to the control or regulation device 5. The control or regulation device 5 can be configured to control or regulate the steering device 9 when simultaneously receiving lane groove detection signals and wet detection signals so that the wheels, in this case the wheels on the right vehicle side and the wheels on the left vehicle side of the EGO vehicle 100 respectively have an offset from the two detected lane grooves 10, 11 so that a prevailing hydroplaning risk is mitigated. Alternatively the control or regulation device 5 can be configured to automatically exit the lane groove following mode when lane groove detection signals and wet detection signals are received simultaneously.

When the EGO vehicle 100 has been steered by the steering or regulation device 5, initially in dry weather conditions in the lane groove following mode so that the vehicle follows the two lane grooves 10, 11 but rain starts during the trip which makes the driving surface 1 wet, thus when there is a transition from a dry driving surface to a wet or humid driving surface 1 during the trip a nominal driving trajectory of the EGO vehicle 100 can be adjusted to that the wheels on the right vehicle side and the wheels on the left vehicle side of the EGO vehicle 10 respectively have an offset from the two detected lane grooves 10, 11 that are filled with water. Alternatively, the lane groove following mode can also be automatically exited in this situation. These exceptions, however, do not contradict the basic strategy that the EGO vehicle 100 should travel in lane groove following mode as a principle with at least two wheels of a vehicle side in a lane groove 10, 11.

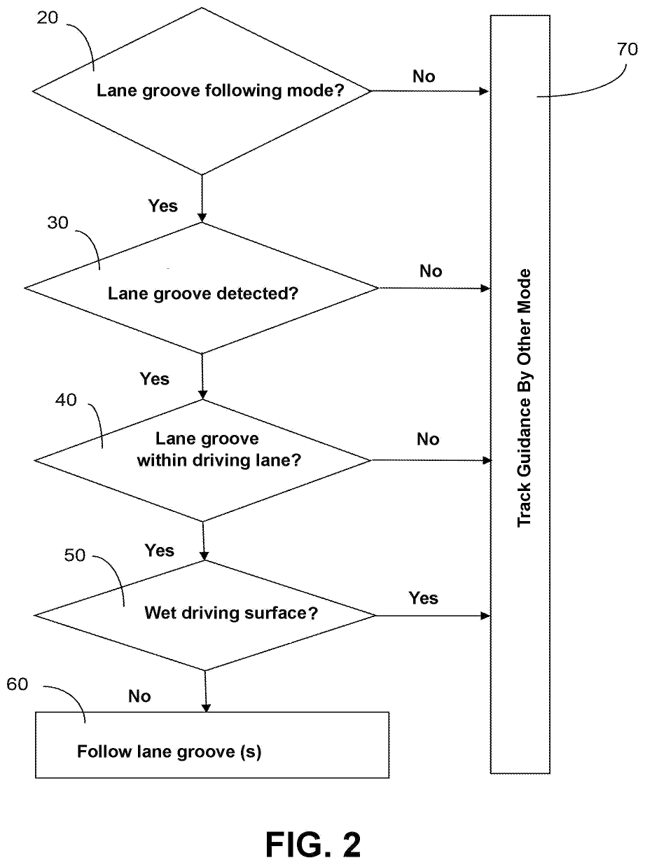

FIG. 2 shows a flow chart of an advantageous embodiment of the method for automatic track guidance of the EGO vehicle 100 by the track guidance system 4 described supra. The method is implemented in an executable program which is stored e.g. in a memory of the control or regulation device 5.

In step 20, it is being checked whether the lane groove following mode has been activated e.g. by the man-/machine interface. If this is not the case. (no) the track guidance of the EGO vehicle 100 is performed by another mode of the track guidance system 4 according to step 70.

When this is the case (yes) it is being checked according to step 30 whether the image capture device 6 has detected a lane groove or plural lane grooves 10, 11 shown in FIG. 1 on or in the right driving lane 2. When this is not the case (no) the lane groove following mode is automatically terminated and the track guidance of the EGO vehicle 100 is performed by another mode of the track guidance system 4 according to step 70.

However, when this is the case (yes) the lane groove following mode is continued and it is being checked in step 40 whether the lane groove 10, 11 continues within the driving lane 2 or runs out of the driving lane 2. If it is determined that the lane groove 10, 11 runs out of the driving lane 2 (no) the lane groove following mode is automatically terminated and the track guidance of the EGO vehicle 100 is performed by another mode of the track guidance system 4 according to step 70.

However if this is the case (yes) this means the lane groove 10, 11 continues to run within the driving lane 2 the lane groove following mode is continued and it being checked in step 50 whether the driving surface is wet. If this is the case (yes) the image capture device has detected a wet driving surface 1 or driving lane 2 so that there is a hydroplaning risk and therefore the lane groove following mode is automatically terminated and subsequent track guidance of the EGO vehicle 100 is performed by another mode of the track guidance system 4 according to step 70.

If this is not the case (no) the image capture device has not detected a wet driving surface 1 or driving lane 2 or has detected a dry driving surface 1 or driving lane 2 so that there is no hydroplaning risk and therefore the lane groove following mode is continued so that the EGO vehicle 100 follows the detected lane groove 10, 11 in step 60. The sequence of steps 40 and 50 can certainly also be inverted.

### REFERENCE NUMERALS AND DESIGNATIONS

1 driving surface
2 right driving lane
3 left driving lane
4 track guidance system
5 control or regulation device
6 image capture device
7 driving surface boundary
8 center line
9 steering device
10 right lane groove
11 left lane groove
20-70 method steps
100 EGO vehicle

What is claimed is:

1. A method for automatically guiding a track of a vehicle which includes at least two wheels on each vehicle side and a track guidance system which is able to detect at least one lane groove within a driving lane, the method comprising:
influencing a track guidance of the vehicle as a function of a detection of the at least one lane groove,
wherein the track guidance system includes a lane groove following mode in which the track guidance of the vehicle is influenced by the track guidance system after the at least one lane groove has been detected so that the vehicle follows the at least one detected lane groove in that at least two wheels at least at one vehicle side are caused to overlap the at least one detected lane groove.

2. The method according to claim 1, wherein the automatic track guidance of the vehicle is performed by the track guidance system as a function of detected vehicle environment parameters which differ from the at least one detected lane groove when no lane groove has been detected by the track guidance system or in a mode of the track guidance system that differs from the lane groove following mode.

3. The method according to claim 1, wherein the track guidance of the vehicle is influenced by the track guidance system when the track guidance system has detected two substantially parallel lane grooves within the driving lane, namely a first lane groove and a second lane groove, so that the vehicle follows the two substantially parallel lane grooves by causing at least two wheels on a first vehicle side to overlap with a first detected lane groove of the two substantially parallel lane grooves and causing at least two wheels on the second vehicle side to overlap with a second detected lane groove of the two substantially parallel lane grooves.

4. The method according to claim 1, wherein the track guidance system controls or regulates the vehicle in the lane groove following mode so that the vehicle only follows the at least one detected lane groove when the track guidance system has detected that the at least one detected lane groove is within a driving lane and the vehicle moves within lane boundaries of the driving lane when following the at least one detected lane groove.

5. The method according to claim 1, wherein the track guidance system is able to detect a wet driving surface in the lane groove following mode and wherein the track guidance system only influences the track guidance of the vehicle to follow the at least one detected lane groove when the track guidance system has not detected the wet driving surface.

6. A track guidance system able to automatically guide a track of a vehicle which includes at least two wheels on each vehicle side, the track guidance system comprising:
a control or regulation device;
a sensor device able to detect vehicle environment parameters and at least one lane groove within a driving lane among detected vehicle environment parameters wherein the sensor device generates lane groove detection signals when detecting the at least one lane groove and feeds the lane groove detection signals into the control or regulation device;
at least one actuator controlled or regulated by the control or regulation device as a function of the detected vehicle environment parameters wherein the actuator influences a track guidance of the vehicle,
wherein the control or regulation device is configured to control or regulate the at least one actuator as a function of the lane groove detection signals,
wherein the track guidance system includes a lane groove following mode,
wherein the control or regulation device is able to control or regulate the at least one actuator in the lane groove following mode when receiving the lane groove detection signals so that the vehicle follows the at least one detected lane groove by causing at least two wheels at least at one vehicle side to overlap with the at least one detected lane groove.

7. The track guidance system according to claim 6, configured so that in the event that the sensor device has not generated any lane groove detection signals or in a mode of the track guidance system that differs from the lane groove following mode, the control or regulation device controls the at least one actuator so that the track guidance of the vehicle is performed as a function of the vehicle environment parameters detected by the sensor device which differ from the at least one detected lane groove.

8. The track guidance system according to claim 6, configured so that in the event that the sensor device has detected two substantially parallel lane grooves within the driving lane, namely a first lane groove and a second lane groove, and corresponding lane groove detection signals have been fed to the control or regulation device, the control or regulation device controls the at least one actuator so that the vehicle follows the two detected substantially parallel lane grooves in that at least two wheels on a first side of the vehicle are caused to overlap with a first detected lane groove of the two detected substantially parallel lane grooves and at least two wheels on a second side of the vehicle are caused to overlap with a second detected lane groove of the two detected substantially parallel lane grooves.

9. The track guidance system according to claim 6, wherein the control or regulation device is configured to control or regulate the at least one actuator when the lane groove detection signals are received so that the vehicle only follows the at least one detected lane groove when the sensor device has detected that the at least one detected lane groove is within the driving lane and that the vehicle moves within lane boundaries of the driving lane when following the at least one detected lane groove.

10. The track guidance system according to claim 6, wherein the sensor device is configured to detect a wet driving surface and feed corresponding wet detection signals to the control or regulation device, wherein the control or regulation device controls or regulates the at least one actuator when simultaneously receiving the corresponding wet detection signals and the lane groove detection signals so that the wheels of the vehicle have an offset from the at least one detected lane groove.

11. The track guidance system according to claim 6, wherein the actuator includes a steering device or a braking device of the vehicle.

12. The track guidance system according to claim 6, wherein the sensor device includes an image capture device including at least one camera.

13. The track guidance system according to claim 6, configured so that that it performs semi-autonomous or autonomous track guidance of the vehicle.

14. The tack guidance system according to claim 6, wherein the lane groove following mode can be selected from a number of modes for tracking the vehicle.

15. A vehicle, comprising the track guidance system according to claim 6.
